(19) United States
(12) Patent Application Publication
(10) Pub. No.: US 2004/0153470 A1
(43) Pub. Date: Aug. 5, 2004

(54) Method for automatically generating current distribution order data

(75) Inventor: Graeme McLintock, Konstanz (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/763,216

(22) Filed: Jan. 26, 2004

Related U.S. Application Data
(63) Continuation of application No. PCT/DE02/02852, filed on Aug. 2, 2002.

(30) Foreign Application Priority Data
Aug. 9, 2001 (DE) 101 39 249.4

(51) Int. Cl. G06F 17/00

(52) U.S. Cl. 707/102

(57) ABSTRACT

The invention relates to a method for automatically producing actual distributed data sequences, integrating, as distributed data sequences, central address tables which are stored in data bases and transmitted by electronic data transfer. The inventive method comprises the following steps: the actual central address table, or parts thereof concerning the relevant area, is locally copied; locally stored modification instructions are transferred, in terms of the relative change of position of feed points in the distributed sequence, for the previous version of the central address table or relevant parts thereof, the feed points being identified by identification data containing at least the sorting code, to the local copy of the actual central address table or the relevant parts thereof; it is checked whether the modification instructions in the copied actual address table have already been executed or whether they are still to be executed; the valid modification instructions which are still to be executed are stored in an audit file and the modification instructions are executed.

### CROSS REFERENCE TO RELATED APPLICATIONS

The present application is a continuation of International Application Number PCT/DE02/02852, filed Aug. 2, 2002; and further claims priority to German Application DE 10139249.4, filed Aug. 9, 2001, the both of which are herein incorporated by reference.

### BACKGROUND OF THE INVENTION

The invention relates to a method for automatically generating current distribution order data with the inclusion of central address directories, which are stored in databases and are transmitted by data transfer, as distribution order data.

Modern mail organizations have a central electronic address directory (ZAV) recording all addresses to which deliveries can be made (delivery points). The address directory (ZAV) is the information basis for a plurality of mail applications and is regularly updated, e.g. on a monthly basis. Changes are typically made on the basis of requests by the users of the mail applications based on the ZAV, e.g. mail deliverers. The ZAV data frequently have a hierarchic structure: delivery districts, delivery sections (groups of delivery points) and delivery points.

The introduction of new services and, in particular, of new levels of automation, e.g. distribution order sorting, results in new demands on a ZAV system. Additional application-specific data need to be stored. To avoid changes to the ZAV system, new application systems are installed which can store and process the application-specific data. Normally, such an application system stores a copy of the ZAV, which is transferred via an existing file-oriented interface, internally. Changes to the central ZAV data stock require replication of the new data stock in the application systems.

Such an application system, the distribution order manager (VFM), is necessary in order to perform distribution order sorting. At this automation level, the dispatches are sorted by computer into the order in which the dispatches are delivered by the deliverer. This dispenses with the time-consuming manual sorting of the dispatches before delivery. The VFM is used to prepare sorting schedules in which the order of the mail dispatches is prescribed and which are loaded by the distribution order sorting installations. The VFM also needs to store Quality of Service (QoS) features, such as “deliver on Tuesday only”, with the address data. These QoS features are evaluated by the VFM in order to keep the sorting schedules current on a daily basis.

One problem when processing the ZAV data in the VFM is incorrect or incomplete data records. The ZAV contains either no sequence statements at all or only imprecise sequence statements for prescribing the distribution order. The delivery order required by the deliverers may change on a daily basis for other reasons too, e.g. cover in the event of illness. These changes need to be able to be made immediately so as not to impair the efficiency of the distribution order sorting. For this reason and to make the QoS information maintainable in situ, the VFM systems are preferably installed on separate computers in situation in the sorting installations.

Every VFM is therefore generally responsible for a separate mail area, and its data stock does not need to be aligned with that of the other VFMs. However, on the basis of this architecture, new versions of the ZAV need to be replicated on a plurality of VFMs and need to be integrated there with local changes in the previous version. This replication would be simple to implement if the ZAV system were to provide a log file for the changes (as customary for merge relocation between database systems (Microsoft SQL Server 2000 Reference Library (ISBN 0-7356-1280-3))) or if the VFM system were to permit no changes to the data (read-only snapshots (Buretta, Marie “Data Replication:Tools and Techniques for Managing Distributed Information”, (ISBN 0-471-15754-6))). If the VFM were implemented with an industrial standard DBMS (Database Management System) and replication service, it would be possible to compensate for the absent change history (log file). However, it should be possible to operate the VFM from a plurality of terminals, which, together with a number of distributed VFM computers, can mean considerable license costs for a DBMS. The ZAV data are also intended to be used as a master version, and the distribution order data as a replica (asymmetric replication [Buretta, Marie “Data Replication:Tools and Techniques for Managing Distributed Information”, (ISBN 0-471-15754-6)]). Implementation without a DBMS or log files for the ZAV changes would therefore make automatic conflict resolution difficult.

### SUMMARY OF THE INVENTION

The invention is based on the object of affording a simple method for automatically generating current distribution order data with the replication of ZAV data stocks and with local changes without a database management system.

The invention is also intended to allow the integration of centrally maintained Quality of Service features, e.g. forwarding requests, the simple integration of changes made in parallel and also the complementing and correction of an existing address directory by means of incremental changes.

The invention achieves the object by means of the features of claim 1.

As a result of the following steps:

the current central address directory or the parts relating to the relevant area is/are copied locally,

locally stored change instructions regarding a relative positional change for delivery points in the distribution order for the previous version of the central address directory or of the relevant parts (the delivery points being identified on the basis of identification data containing at least the sorting code) are transferred to the local copy of the current central address directory or of the relevant parts,

a check is carried out to determine whether the change instructions have already been implemented in the copied current address directory or whether they are yet to be executed,

the valid change instructions yet to be executed are stored in an audit file and the change instructions are executed,

it is no longer necessary to make and manage the changes using a database management system.

If a new version of the central address directory is enabled at a later time, the new data stock is simply imported as a new version of the distribution order data by the VFM. Thereafter, the change instructions stored in the previous version's audit file can automatically be applied to the new version by an editor program. In this context, the changes are also written to the new version's initially empty audit file and are thus forwarded from version to version.

On the basis of the method, context information from the identification data is provided in the audit file in order to permit a semantic check on the validity of the audit file entries during application thereof. As a result, only the changes which are still valid are transferred from one version to the next. Another important basis of this method is that the audit entries are in a form such that they not only permit the simple transfer of the data changes but also allow simultaneous checking of the validity of the change instructions.

Whenever a new version of the ZAV data has been replicated, a new version of the distribution order data is produced on every VFM. Each VFM processes only the ZAV data for its field of responsibility, which means distribution and parallelization of the work. Complicated merging of the ZAV data stocks and distribution order data stocks is dispensed with in this master/slave method. By creating a new version of the distribution order data, the old data stock will automatically still exist for backup. When the sorting schedules for the sorting installations are generated, only one, the current, version of the distribution order data is used.

The use of a plurality of audit files allows a plurality of operators to make changes to the same version of the distribution order data simultaneously. When an operator has finished work, the contents of his audit file is automatically applied to the current data stock, as described above. This makes his changes valid for the first time. Should there be any changes which cannot be made as a result of another operator's changes made in the meantime, the operator can be informed about this and can then process the changed distribution order data again. The structure of the audit file allows an audit file to be generated on the basis of changes to a version of the distribution order data, and then allows this audit file to be applied to a since changed version of the distribution order data.

It is thus advantageous if the identification data additionally contain house number extensions. It is also advantageous if the identification data additionally contain distinguishing remarks, e.g. “no delivery on Tuesday” or “deliver to new address from a particular date”.

To incorporate this forwarding or distribution advice into the copied address directory, it is advantageous first to check whether the delivery point for the respective forwarding and/or distribution advice exists in the copied current address directory for the distribution order data. If so, the new forwarding and/or distribution advice is added to the copied address directory, in which case new advice replaces old advice of the same type, and the complete change data for the forwarding and/or distribution advice are transferred to the audit file.

Centrally maintained QoS features are thus integrated into a copy of the address directory's current distribution order data by complementing the existing features with the new features or by correcting them as appropriate. Unlike in the case of the ZAV data, a completely new entry is also written to the audit file associated with the new version for every feature change. As a result, locally and centrally maintained features are transferred to new data stock in future. This method works only because the audit entries for features are stored in the audit file in single form not as a change instruction but rather as a changed data record. This means that the feature data can be transferred in full and without great complexity from one version of the distribution order data to the next. This combined logging of change instructions and data records distinguishes the method of this invention.

In another advantageous refinement, the central address directory or parts of the central address directory is/are updated by transmitting only incremental changes by data transfer. These incremental changes are merged with the copied, previously current address directory or address directory part by using the identification data for each delivery time to check in the previously current address directory or address directory part whether the respective delivery point in the incremental change is already present. If this is not the case, it is incorporated into the copied address directory or address directory part at the concomitantly transmitted position of the distribution order. If the delivery point in the incremental change is already present in the address directory or address directory part, then it is moved to the changed position in the address directory. The moving process is advantageously performed by deleting the delivery point at the previous position of the address directory and re-entering it at the changed position.

As a result, the multiplicity of changes which came along with the new ZAV data are not mixed with the local changes. That is to say, local changes change the data stock but are also logged separately in the new audit file. Local corrections which have since become superfluous can easily be omitted. This method works only on account of the type (which is limited in practice) and scope of the changes in the ZAV data and thus makes it appropriate only for application in the mail field, i.e. addresses are sooner added or moved and are relatively rarely deleted.

### BRIEF DESCRIPTION OF THE SEVERAL VIEWS OF THE DRAWINGS

The invention is explained in more detail below in an exemplary embodiment with reference to the drawings, in which

FIG. 1 shows a structurogram of distribution order sorting systems;

FIG. 2 shows a flowchart for correction/complementing of the distribution order data by an operator;

FIG. 3 shows a flowchart for the import of new distribution order data;

FIG. 4 shows a flowchart for the import of incrementally changed distribution order data;

FIG. 5 shows a flowchart for the import of a feature file; and

FIG. 6 shows a flowchart for the import of an audit file.

### DETAILED DESCRIPTION OF THE INVENTION

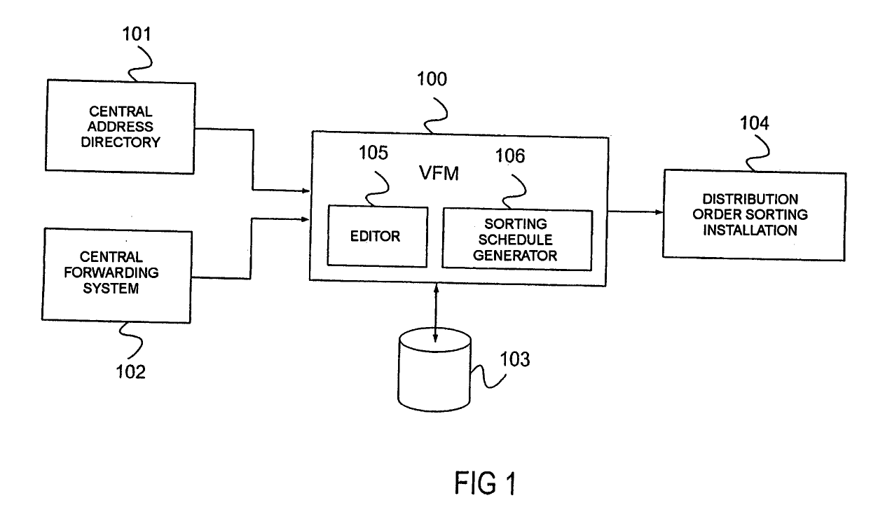

A distribution order manager (VFM) has at least the central address directory (ZAV) data which are relevant to its mail area delivered to it in files by data transfer. FIG. 1 shows the systems required by a mail organization for processing the address data and for distribution order sorting. The VFM 100 receives the ZAV data from the system 101 on which the ZAV data are maintained and uses them to prepare the sorting schedules using a generator program 106 for the distribution order sorting installations 104. If appropriate, there is a second application system 102, which accesses the ZAV data and on which forwarding requests are managed. Other application systems managing further information useful for distribution order sorting are also possible. The forwarding data are also delivered to the VFM by data transfer, e.g. ftp.

The complete ZAV data are taken on by the VFM in full and are stored locally as distribution order data on a hard disk 103. Whenever there is a new version of the ZAV data, a new version of the copied local distribution order data is generated. In this way, the ZAV data are replicated in the master/slave mode.

Quality of Service (QoS) features are not contained in the ZAV data; they are maintained locally on the VFM by the operator and are stored with the appropriate version of the distribution order data. The operator can also use an editor program 105 to correct or complement the distribution order data in order to take into account changes in the picture of the road, e.g. new houses which are not yet known in the ZAV system, in the distribution order sorting.

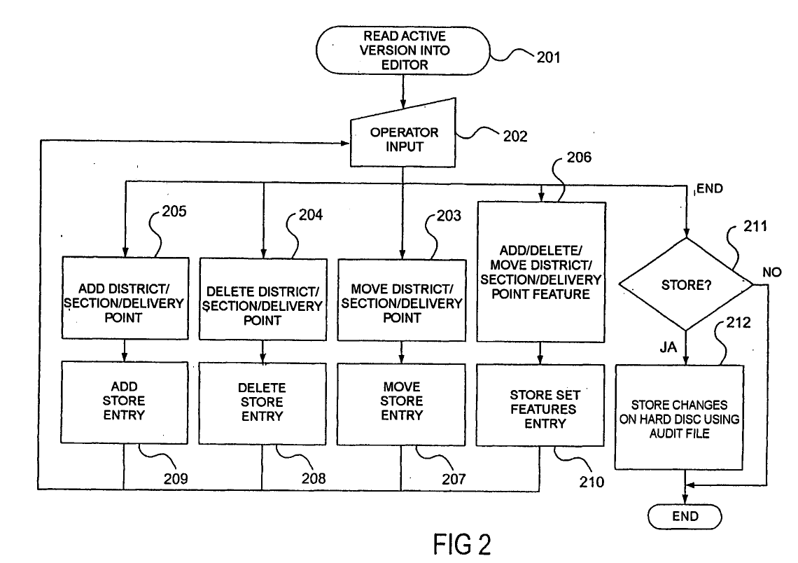

FIG. 2 shows the maintenance of the distribution order data by an operator using an editor 105 in the form of a flowchart. First, the version of the distribution order data which is to be processed is read 201 from the hard disk. Thereafter, the editor reacts to user inputs which make 202 changes to the data. Changes to the address data can be made at various levels of the hierarchy in order to move 203 or to delete 204 or to add 205 one or more delivery districts, one or more delivery sections or individual/a plurality of distribution points. These operations change the data and are respectively logged as audit entries of the type MOVE 207, DELETE 208 and ADD 209 at the same time. Should the operator add, delete or move 206, QoS features for a delivery point/section/district, all the changes are logged 210 in the audit file using a SET features entry. Should the operator wish to store 211 the changed data after editing, the distribution order data are stored and the new audit entries are added 212 at the end of the audit file.

The design of the audit entries is a fundamental basis of this method and is documented in table 1.

TABLE 1

| Operation | Parameter 1 | Parameter 2 | Parameter 3 |
|---|---|---|---|
| MOVE | First | Last | Before/after |
| Delivery | delivery | delivery | delivery |
| point | point | point | point |
| ADD | New delivery | Before/after | |
| Delivery | point | delivery | |
| point | | point | |
| DELETE | Delivery | | |
| Delivery | point | | |
| point | | | |
| MOVE section | First | Last section | Before/after |
| | section | | section |
| ADD section | New section | Before/after | |
| | | section | |
| DELETE | Section | | |
| section | | | |
| MOVE district | First | Last | Before/after |
| | district | district | district |
| ADD district | New district | Before/after | |
| | | district | |
| DELETE | District | | |
| district | | | |
| SET features | Delivery | All features | |
| | point | | |

For ADD and DELETE entries, the delivery point, section or district in question is indicated as a parameter in the entry.

All details relating to delivery points, section or districts are always concomitantly stored, e.g.

for delivery points:

district ID, section ID, sort code, zip code, road name, house number, house number extension, remark;

for delivery sections:

district ID, section ID, section name;

for delivery districts:

district ID, district name.

For ADD entries, the place in the distribution order at which the delivery point/section/district is meant to be added is also distinguished. Instead of a position number, the corresponding place is noted using the delivery points/sections/districts coming before/after. A MOVE entry is also provided with delivery points/sections/districts coming before/after as parameters. Because a MOVE entry can move more than one delivery point/section/district simultaneously as one cohesive field, the field is indicated with the first and the last delivery point/section/district.

The use of a before or after entry instead of a position number makes the target position of a move dependent not on the absolute, but rather on the relative, order of the delivery points.

Section changes are logged relative to a section, and district changes are logged relative to a district. These relative statements, together with the fact that the real geography of the delivery points remains static, mean very effective transfer of the audit entries.

QoS features are input using the editor and are stored as SET audit entries. A fundamental portion of an audit file comprises SET features instructions. Because each delivery point/section/district is generally provided with only a few QoS features, the evaluation of the audit file is kept simple by virtue of all the features which are present for a delivery point/section/district always being indicated in each SET entry. As a result, only the last SET entry needs to be evaluated for each delivery point/section/district. When loading the distribution order data 201, superfluous SET entries can easily be ignored, which compresses the audit file after re-storage.

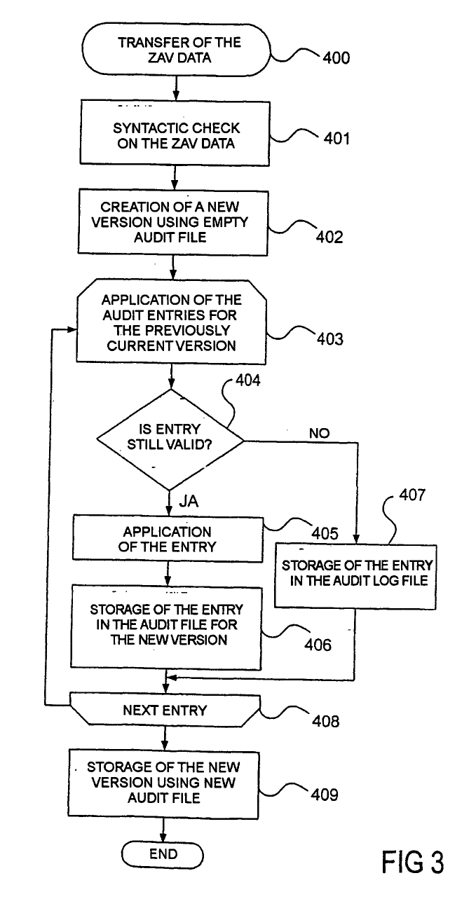

Reading a new complete version of the ZAV data and creating a new version of the distribution order data starts, as shown in FIG. 3, with the transfer of the new ZAV data 400. A syntactic check on the ZAV data in order to ensure the correctness and completeness of the data records is performed first 401. To transfer local changes, made in the meantime, to the new version of the data, it is necessary to be able to identify the data records from one version to the next. Districts and sections are defined in the ZAV data merely as a quantity of delivery point data records and are produced as required in the distribution order data. To identify delivery point data records, identification data are formed from a delivery point's sorting code+house number extension+remark. The sorting code is the target for the sorting and is frequently printed as a barcode on mail dispatches during automated mail distribution. The sorting code does not have to comprise a zip code, a road name and a house number. However, the method becomes more effective if unique abstract sorting codes are used. Since generally not all delivery points are provided with a unique sorting code, the house number extension (often alphabetical) and the remark (e.g. “butcher's), if present, need to be taken into account. Districts and sections generally have an identifier which is suitable for the identification. It is also necessary to ascertain 402 whether the aforementioned identifiers and identification data are unique. All unique data records are stored in the new distribution order data version, together with an empty audit file 402.

Thereafter, the entries in an existing audit file, e.g. from the previously current version of the data, can be applied 403 to the new data in order to transfer all local changes. In this case, it is first necessary to check 404 the validity of each entry. The entry is no longer valid, by way of example, if the delivery point to be moved is already at the correct place. All valid entries are applied 405 by the editor program. When processing the audit entries for the previously current version, audit entries for the new version of the distribution order data are produced. These audit entries for the new version are buffer-stored 406. All audit entries which are no longer valid are stored 407 in a log file and can be inspected by the operator as required. When all the audit entries have been processed 408, the new version of the distribution order data can be stored 409 using a generally smaller audit file.

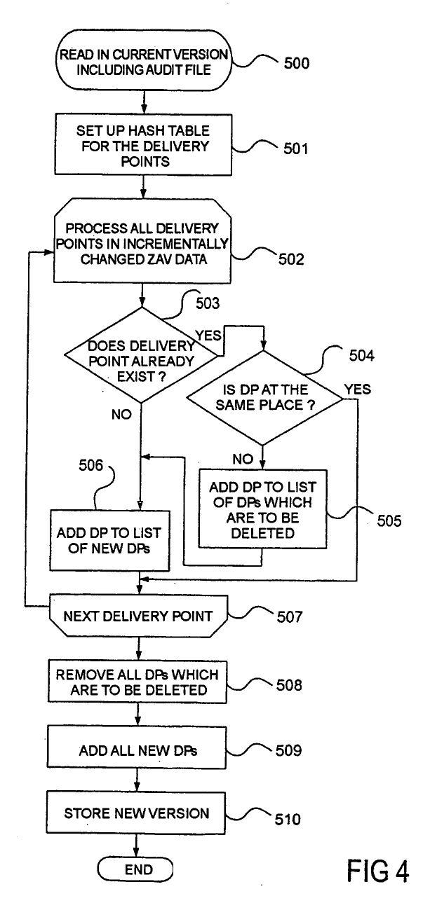

If the updated versions of the ZAV data are provided only as incremental data stocks, each data stock is combined with the previously current version of the distribution order data to form a new full version of the distribution order data. As depicted in FIG. 4, the current version of the distribution order data is first read 500 from the hard disk. This typically involves setting up 501 a hash table in accordance with normal programming technology in the memory in order to allow the delivery points to be subsequently found quickly. The key used in the hash table is the aforementioned identification data formed from a delivery point's sorting code+house number extension+remark. However, some ZAV data stocks do not know any sorting codes, and in this case the correct sorting code is generated during import.

All new delivery points are processed 502 in succession, and first of all a check is carried out to determine whether the delivery point already exists 503. If the new delivery point does already exist, its relative position is compared 504 with the previous relative position. Should the positions be the same, no further action is necessary. If the positions are different, the delivery point is entered 505 into a list of delivery points which need to be deleted. These delivery points which are to be moved are also entered 506, like new delivery points, into a list of the new delivery points. When all delivery points have been processed 507, all the delivery points which are to be deleted are removed 508 from the data stock. All new or moved delivery points are then added 509. Lastly, the new version of the distribution order data can be stored 510. In this case, empty sections and also empty districts are omitted.

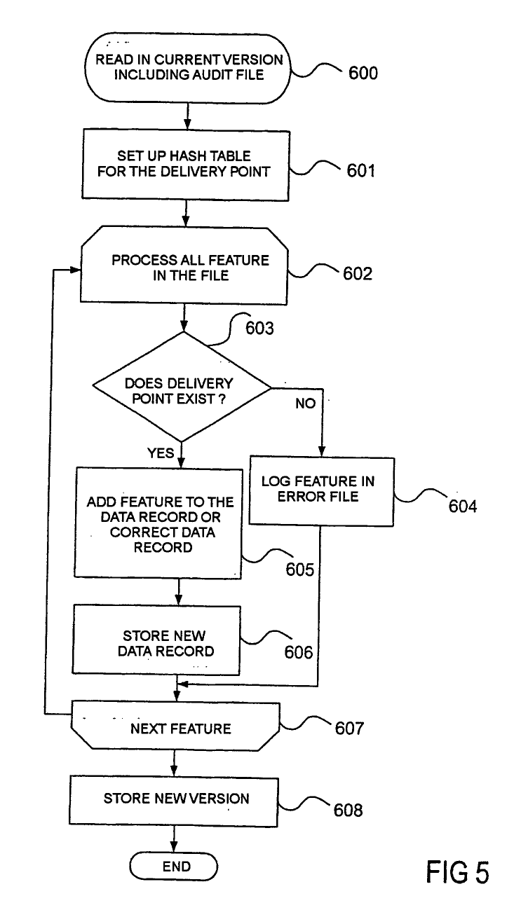

The QoS features from another central application system are provided in the form of a file. A feature file can be combined with the current version of the distribution order data to form a new version. As depicted in FIG. 5, this first involves the current version of the distribution order data being read 600 from the hard disk. This involves setting up 601 a hash table in accordance with normal programming technology in the memory, as already described above. All the features in the file are processed 602 in succession, with a check first being carried out to determine whether the delivery point in question actually exists 603. If the delivery point does exist, the previous features are combined with the new features, with the new features having priority 605. The complemented data record is stored 606 in the distribution order data and as a complete SET entry in the audit file. Should the delivery point in question not exist, an entry is logged 604 in an error file. When all the delivery points have been processed 607, the new version of the distribution order data is stored.

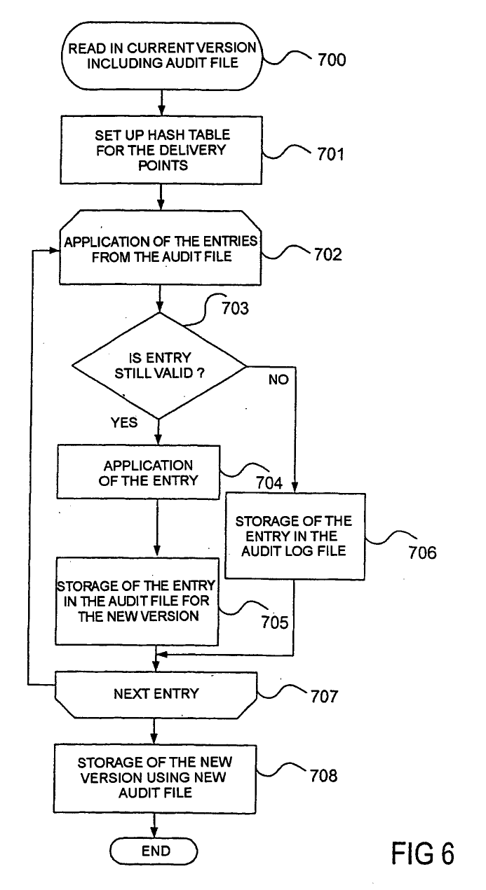

Individual audit files can be combined with the current version of the distribution order data to form a new full version. This functionality allows parallel processing of the distribution order data by a plurality of operators. As depicted in FIG. 6, this first involves the current version of the distribution order data being read 700 from the hard disk. This involves setting up 701 a hash table in accordance with normal programming technology in the memory, as already described above. All audit entries from the audit file are processed 702, and a check is first carried out to determine whether each entry is still valid 703. If it is not possible to apply an entry, for example because the delivery point is missing, the entry is stored 706 in the audit log file. If it is possible to apply the entry, however, the change is made 704, and a new entry is stored 705 in the new audit file. When all the audit entries have been processed, the new version of the distribution order data is stored 708.

I claim:

1. A method for automatically generating current distribution order data with the inclusion of central address directories, which are stored in databases and are transmitted by electronic data transfer, as distribution order data, having the following steps:
the current central address directory or the parts relating to the relevant area is/are copied locally,
locally stored change instructions regarding a relative positional change for delivery points in the distribution order for the previous version of the central address directory or of the relevant parts (the delivery points being identified on the basis of identification data containing at least the sorting code) are transferred to the local copy of the current central address directory or of the relevant parts,
a check is carried out to determine whether the change instructions have already been implemented in the copied current address directory or whether they are yet to be executed,
the valid change instructions yet to be executed are stored in an audit file and the change instructions are executed.

2. The method as claimed in claim 1, where the identification data additionally incorporate house number extensions locally.

3. The method as claimed in claim 1, where the identification data additionally incorporate distinguishing remarks locally.

4. The method as claimed in claim 3, where forwarding and/or distribution advice is incorporated into the copied address directory by carrying out the following steps:
a check is carried out to determine whether the delivery point for the respective forwarding and/or distribution advice exists in the copied current address directory for the distribution order data, and if so
the new forwarding and/or distribution advice is added to the copied address directory, with the new forwarding and/or distribution advice having priority over the old forwarding and/or distribution advice of the same type, and
the complete change data for the forwarding and/or distribution advice are incorporated into the audit file.

5. The method as claimed in claim 1, where the central address directory or address directory parts is/are updated by transmitting only incremental changes by data transfer, which are merged with the previously current and copied address directory or address directory part by using the identification data for each delivery point to check in the previously current address directory or address directory part whether the respective delivery point in the incremental change is already present, and if not, it is incorporated into the copied address directory or address directory part at the concomitantly transmitted position of the distribution order, and if so, the respective delivery point is moved to the changed position in the address directory.

6. The method as claimed in claim 5, where the move of a delivery point is implemented by deleting said delivery point at the previous position of the address directory and re-entering it at the changed position.
